(19) United States
(12) Patent Application Publication
(10) Pub. No.: US 2013/0104758 A1
(43) Pub. Date: May 2, 2013

(54) INTAGLIO PRINTING PRESS

(71) Applicant: KOMORI CORPORATION, Tokyo (JP)

(72) Inventor: Hiroyoshi KAMODA, Tsukuba-shi (JP)

(73) Assignee: KOMORI CORPORATION, Tokyo (JP)

(21) Appl. No.: 13/659,999

(22) Filed: Oct. 25, 2012

(30) Foreign Application Priority Data
Oct. 26, 2011 (JP) 2011-234648
Sep. 11, 2012 (JP) 2012-199066

(51) Int. Cl. B41F 9/00

(52) U.S. Cl. 101/153

(57) ABSTRACT

An intaglio printing press includes a feeder, an intaglio printing unit, and a delivery unit and is configured to perform intaglio printing on a paper sheet W having been subjected to printing in a previous step. The intaglio printing press comprises a first inspection camera provided between the feeder and the intaglio printing unit and configured to inspect one surface of the paper sheet having been subjected to the printing in the previous step.

### TECHNICAL FIELD

The present invention relates to an intaglio printing press capable of performing highly accurate quality inspection on previous printing by use of appropriate equipment.

### BACKGROUND ART

A basic printing process for bank notes, securities, and the like is formed of offset printing, intaglio printing, and number printing in the mentioned order. Moreover, in general, the printing process goes through an inspection step after the intaglio printing and then proceeds to the number printing at the final step.

Patent Literature 1, for example, discloses an intaglio printing press in which a line camera and illuminating units for inspecting a sheet are provided above an impression cylinder of an intaglio printing device within a region which is downstream, in the rotational direction of the impression cylinder, of a position where the impression cylinder is in contact with a set of intaglio printing plates of a plate cylinder but is upstream, in the rotational direction of the impression cylinder, of a position where a sheet is transferred from the impression cylinder to a delivery cylinder of a sheet delivering device.

{Citation List}

{Patent Literature}

{Patent Literature 1} Japanese Patent Application Publication No. 2012-61602

### SUMMARY OF INVENTION

{Technical Problem}

Meanwhile, the intaglio printing press disclosed in Patent Literature 1 is the one that includes an inspection device for evaluating the printing quality of a surface subjected to intaglio printing after the intaglio printing is performed. Here, prior to the intaglio printing, the other surface (non-intaglio-printing surface) of the sheet opposite to the surface subjected to the intaglio printing has been subjected to previous printing such as offset printing in the case of printing a bank note, a security or the like, for example. Thus, it is necessary to inspect this non-intaglio-printing surface before proceeding to the number printing at the final step.

It is preferable to mount an inspection device on a printing press that performs the previous printing so that a single printing press can perform both the previous printing and quality inspection thereof. The reality, however, is that there is no space to install an inspection device in double-sided offset printing presses that perform bank-note printing, for example. Hence, it has been desired to perform highly accurate quality inspection on the previous printing by use of appropriate equipment.

Thus, an object of the present invention is to provide an intaglio printing press capable of performing highly accurate quality inspection on previous printing by use of appropriate equipment.

{Solution to Problem}

To attain the object, an intaglio printing press according to the present invention is provided with a sheet feeding device, an intaglio printing device, and a sheet delivering device, and is configured to perform intaglio printing on a sheet having been subjected to printing in a previous step, which is characterized in that the intaglio printing press includes a first inspection device provided between the sheet feeding device and the intaglio printing device and configured to inspect printing quality of the sheet having been subjected to the printing in the previous step.

The intaglio printing press is characterized in that the first inspection device is configured to inspect one surface of the sheet opposite to a surface thereof to be subjected to the intaglio printing by the intaglio printing device, and the intaglio printing press further includes a second inspection device configured to inspect the other surface of the sheet subjected to the intaglio printing by the intaglio printing device.

The intaglio printing press is characterized in that the intaglio printing device includes an impression cylinder configured to hold and transport the sheet, and an intaglio cylinder being in contact with the impression cylinder and configured to perform the intaglio printing on the other surface of the sheet transported on the impression cylinder, and the first inspection device is disposed in such a way as to face a transport cylinder arranged upstream of the impression cylinder in a transport direction of the sheet and configured to transport the sheet while holding the sheet with the one surface thereof facing outside.

The intaglio printing press is characterized in that the second inspection device is disposed in such away as to face the impression cylinder of the intaglio printing device.

The intaglio printing press is characterized in that the sheet delivering device includes a normal-sheet stacking device to stack the sheet determined as normal as a result of the inspection by any one of the first inspection device and the second inspection device, a defective-sheet stacking device to stack the sheet determined as defective as a result of the inspection by any one of the first inspection device and the second inspection device, and a switching device configured to switch the destination to which the sheet is delivered.

{Advantageous Effect of Invention}

With the intaglio printing press according to the present invention, a sheet can be subjected to the quality inspection on the previous printing before being subjected to the intaglio printing, inside the same intaglio printing press which has relatively enough space for installation. Accordingly, it is possible to perform highly accurate quality inspection on the previous printing by use of appropriate equipment.

### BRIEF DESCRIPTION OF DRAWINGS

FIG. 1 is an overall configuration diagram of an intaglio printing press showing an embodiment of the present invention.

FIG. 2 is an enlarged diagram of a main part of an intaglio printing unit.

FIG. 3 is a control block diagram regarding switching of the destination of paper-sheet delivery.

### DESCRIPTION OF EMBODIMENTS

Hereinafter, an intaglio printing press according to an embodiment of the present invention will be described in detail by using the drawings.

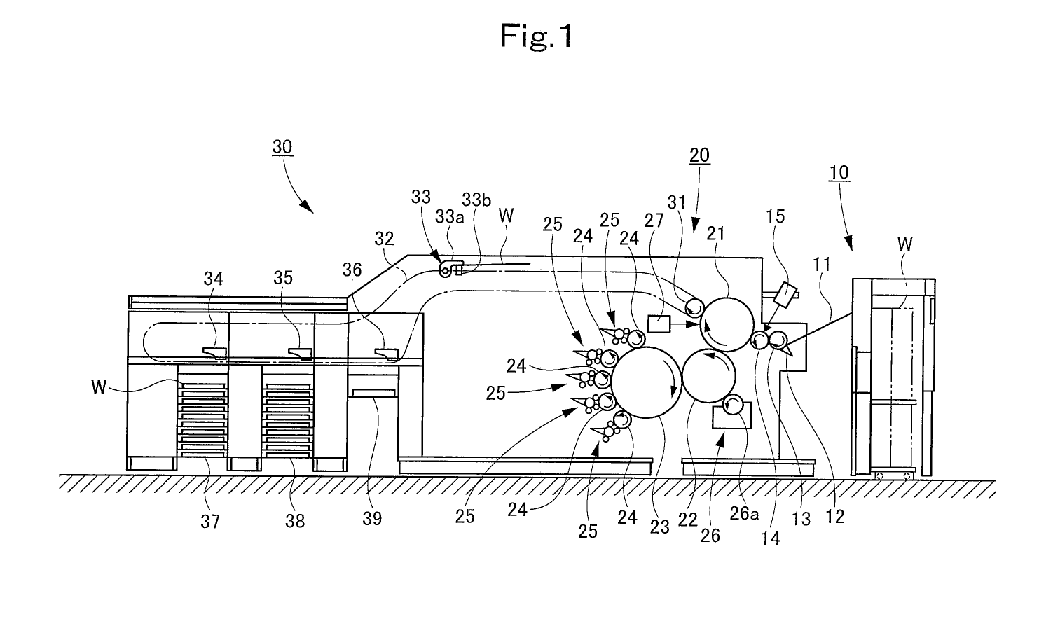

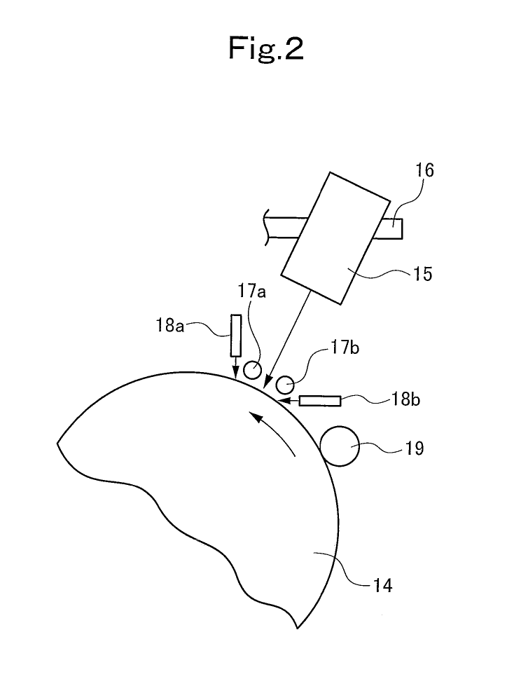

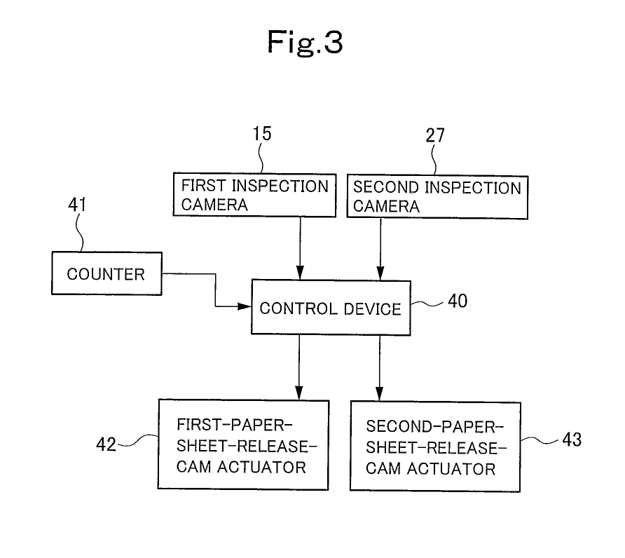

FIG. 1 is an overall configuration diagram of an intaglio printing press showing an embodiment of the present invention. FIG. 2 is an enlarged diagram of a main part of an intaglio printing unit. FIG. 3 is a control block diagram regarding the switching of the destination of paper-sheet delivery.

As shown in FIG. 1, the intaglio printing press is mainly formed of a feeder (sheet feeding device) 10, an intaglio printing unit (intaglio printing device) 20, and a delivery unit (sheet delivering device) 30.

Paper sheets (sheets) W having been subjected to double-sided printing (e.g. double-sided offset printing) in a previous step are stacked in the feeder 10, and a feeder board 11 communicates with this feeder 10. The feeder board 11 is configured to receive and register the paper sheets W sent out individually from the top layer by means of a sucker mechanism of the feeder 10. On a tip of the feeder board 11, a swing device 12 is arranged which is configured to grip and swing the paper sheet W on the feeder board 11.

In the intaglio printing unit 20, a so-called triple-size impression cylinder 21, on which three grippers are arranged at an equal interval in the circumferential direction and to which three rubber blankets can be attached communicates with the swing device 12 through two transfer cylinders 13 and 14.

The transfer cylinders 13 and 14 are provided with grippers which are similar to the grippers of the impression cylinder 21 so that the paper sheet W gripped by the swing device 12 can be relayed sequentially through the grippers of the transfer cylinders and then to the grippers of the impression cylinder 21.

Moreover, above the second transfer cylinder (transport cylinder) 14 from an upstream side in the transport direction of the paper sheet W, there is provided a first inspection camera (first inspection device) 15 such as a CCD line camera configured to inspect the printing quality of the paper sheet W having been subjected to the printing in the previous step.

This first inspection camera 15 is the one that inspects one surface of the paper sheet W opposite to the surface thereof to be subjected to intaglio printing by the intaglio printing unit 20, i.e., a non-intaglio-printing surface. As shown in FIG. 2, the first inspection camera 15 is supported on the machine's frame through a bracket 16 while being directed obliquely downward, and is disposed in such a way as to face a peripheral surface of the transfer cylinder 14.

Above the peripheral surface of the transfer cylinder 14, there are disposed a pair of illuminating units 17a and 17b as well as a pair of air nozzles 18a and 18b which are respectively located upstream and downstream of these illuminating units 17a and 17b in the paper-sheet transport direction and configured to blow pressuring air onto the paper sheet W transported on the transfer cylinder 14. Moreover, a holddown roller 19 is rotatably in contact with the peripheral surface of the transfer cylinder 14 at a position upstream, in the paper-sheet transport direction, of the upstream air nozzle 18b located in the paper-sheet transport direction.

A so-called triple-size plate cylinder 22 to which three intaglio printing plates can be attached along the circumferential direction is in contact with the impression cylinder 21. A so-called quadruple-size ink collecting cylinder 23 to which four rubber blankets can be attached along the circumferential direction is in contact with the set of intaglio printing plates of the plate cylinder 22. Five of so-called single-size chablon rollers 24 having a circumferential length corresponding to the length of the blankets of the ink collecting cylinder 23 and the length of the intaglio printing plates of the plate cylinder 22 are in contact with the ink collecting cylinder 23. Inking devices 25 configured to feed inks are in contact with these chablon rollers 24, respectively. These inking devices 25 are filled with inks of different colors, respectively.

As described above, the ink collecting cylinder 23 is formed as a quadruple-diameter cylinder so that five chablon rollers 24 and five inking devices 25 can be arranged. Here, if the ink collecting cylinder 23 is a triple-size cylinder, only four chablon rollers 24 and four inking devices 25 can be arranged. If the ink collecting cylinder 23 is a quintuple-size cylinder or larger, the machine is too large as a whole. Thus, the quadruple-diameter cylinder is appropriate. Moreover, if the plate cylinder 22 is a double-size cylinder or smaller, it is difficult to install a wiping roller 26a and the like to be described later. If the plate cylinder 22 is a quadruple-diameter cylinder or larger, the machine is too large as a whole. Thus, the triple-diameter cylinder is appropriate. Further, if the impression cylinder 21 differs from the plate cylinder 22 in diameter, misalignment may possibly occur in printing. Thus, the impression cylinder 21 is supposed to be the cylinder of the same diameter, i.e., the triple-size cylinder.

The wiping roller 26a is in contact with the set of the intaglio printing plates of the plate cylinder 22. The wiping roller 26a is dipped in a solvent stored in a wiping tank 26.

Moreover, a second inspection camera (second inspection device) 27 such as a CCD line camera configured to inspect the other surface of the paper sheet W transported on the impression cylinder 21, which has been subjected to the intaglio printing, i.e., an intaglio-printing surface, is disposed in such a way as to face the peripheral surface of the impression cylinder 21 at a position downstream, in the paper-sheet transport direction, of the position of the contact with the plate cylinder 22 but upstream, in the paper-sheet transport direction, of the position of the contact with a paper-sheet delivery cylinder 31 to be described later.

Like the first inspection camera 15, it is also preferable that this second inspection camera 27 be supported on the machine's frame through a bracket and be provided with a pair of illuminating units, a pair of air nozzles, and the like although their illustration is omitted.

In the delivery unit 30, the aforementioned paper-sheet delivery cylinder 31 is in contact with the impression cylinder 21. In addition, paper-sheet delivery chains (transport chains) 32 are wound in an endless manner respectively around a pair of unillustrated sprockets provided coaxially to the paper-sheet delivery cylinder 31. Gripper bars 33 each including a gripper 33a and a gripper pad 33b are provided on the paper-sheet delivery chains 32 at given intervals. Moreover, below the paper-sheet delivery chains 32, two accepted-paper-sheet piles (normal-sheet stacking device) 37 and 38 and one wasted-paper-sheet pile (defective-sheet stacking device) 39 are disposed along the transport direction of the sheet W in this order from an upstream side in that transport direction.

In addition, on one side of each paper-sheet delivery chain 32, there are provided a first paper-sheet release cam 34, a second paper-sheet release cam 35, and a paper-sheet release cam 36, which are located above the accepted-paper-sheet pile 37, the accepted-paper-sheet pile 38, and the wasted-paper-sheet pile 39, respectively. Each of these paper-sheet release cams 34 to 36 is a publicly known cam configured to engage with an unillustrated cam follower provided on the gripper bar 33 side to open the gripper 33a so that the gripped paper sheet W can be released and stacked onto the corresponding pile.

It is also known that the first paper-sheet release cam 34 and the second paper-sheet release cam 35 are each configured as a movable-type cam which moves between an actuated position and a retreat position by means of a first-paper-sheet-release-cam actuator 42 or a second-paper-sheet-release-cam actuator 43 (see FIG. 3), and that the paper-sheet release cam 36 is configured as a fixed-type cam which is immovably fixed. At the actuated position, the first paper-sheet release cam 34 and the second paper-sheet release cam 35 come into contact with the cam follower of the gripper bar 33 to open the gripper 33a and release the paper sheet W. At the retreat position, the first paper-sheet release cam 34 and the second paper-sheet release cam 35 do not engage with the cam follower of the gripper bar 33. In this embodiment, however, the first-paper-sheet-release-cam actuator 42 and the second-paper-sheet-release-cam actuator 43 are configured to be actuated according to detection signals of the aforementioned first inspection camera 15 and the second inspection camera 27, respectively, as shown in FIG. 3.

Specifically, the detection signals of the first inspection camera 15 and the second inspection camera 27 are inputted to a control device (switching device) 40 together with a detection signal of a counter 41. Based on these detection signals, the control device 40 determines whether the paper sheet W is an accepted paper sheet or a wasted paper sheet, that is, whether the paper sheet W is a normal paper sheet or a defective paper sheet. Then, the control device 40 outputs actuation signals to the first-paper-sheet-release-cam actuator 42 and the second-paper-sheet-release-cam actuator 43 accordingly.

More specifically, the paper sheet W determined as an accepted paper sheet on the basis of the detection signals of the first inspection camera 15 and the second inspection camera 27 is delivered to either one of the two accepted-paper-sheet piles 37 and 38. The delivery to either one of the two accepted-paper-sheet piles 37 and 38 is performed by turning ON or OFF the first-paper-sheet-release-cam actuator 42 in accordance with the counter 41 counting a predetermined number of sheets. In this step, the second-paper-sheet-release-cam actuator 43 remains turned ON. Here, ON refers to a state where the paper-sheet release cam 34 or 35 is set at the actuated position so that the paper sheet will be released. OFF refers to a state where the paper-sheet release cam 34 or 35 is set at the retreat position so that the paper sheet will not be released.

Moreover, when the paper sheet W is determined as an wasted sheet (printing defect) on the basis of any of the detection signals of the first inspection camera 15 and the second inspection camera 27, the first-paper-sheet-release-cam actuator 42 and the second-paper-sheet-release-cam actuator 43 are both turned OFF so as to set both the first paper-sheet release cam 34 and the second paper-sheet release cam 35 to their retreat positions. As a result, the paper sheet W is delivered onto the wasted-paper-sheet pile 39 with the paper-sheet release cam 36.

In the intaglio printing press described above, the paper sheets W (having been subjected to the double-sided offset printing in the previous step) sent out individually from the feeder 10 onto the feeder board 11 are each transported by undergoing the relay from the swing device 12 through the transfer cylinders 13 and 14 and then to the impression cylinder 21 by way of their grippers. On the other hand, the inks in the inking devices 25 are transferred through the chablon rollers 24 onto the ink collecting cylinder 23 and then fed onto the surfaces of the intaglio printing plates of the plate cylinder 22. After an excess portion of each ink is removed by the wiping roller 26a, the paper sheet W passes between the impression cylinder 21 and the plate cylinder 22, so that each ink is transferred and printed on the paper sheet W. The paper sheet W is then transported by the paper-sheet delivery chains 32 of the delivery unit 30 through the paper-sheet delivery cylinder 31 and delivered to any one of the piles 37 to 39.

Here, in this embodiment, the one surface or the non-intaglio-printing surface of the paper sheet W which is not subjected to the intaglio printing but has been subjected to the previous printing is inspected by the first inspection camera 15 at the transfer cylinder 14 mentioned above. Then, the other surface or the intaglio-printing surface of the paper sheet W which has been subjected to the intaglio printing is inspected by the second inspection camera 27 at the impression cylinder 21. Based on the inspection results, the control device 40 controls the drive of the first-paper-sheet-release-cam actuator 42 and the second-paper-sheet-release-cam actuator 43 and switches between the delivery to either one of the two accepted-paper-sheet piles 37 and 38 and the delivery to the one wasted-paper-sheet pile 39 as mentioned above.

According to this embodiment, the first inspection camera 15 configured to inspect the printing quality of each paper sheet W having been subjected to double-sided offset printing or the like in the previous step is provided between the feeder 10 and the intaglio printing unit 20. Thus, the quality inspection on the previous printing can be performed prior to the intaglio printing on the intaglio-printing surface of the paper sheet W by use of appropriate equipment within the same machine. Accordingly, it is possible to perform highly accurate quality inspection on the previous printing. Specifically, highly accurate inspection can be performed with the help of sufficient brightness and under stable paper-sheet transportation achieved by the pair of illuminating units 17a and 17b, the pair of air nozzles 18a and 18b, the holddown roller 19, and the like provided in enough space for installation near the single-diameter transfer cylinder 14.

Moreover, the quality inspection on the other surface, or the intaglio printing surface, of the paper sheet W having been subjected to the intaglio printing is performed accurately by the second inspection camera 27 near the impression cylinder 21 by use of appropriate equipment as in the case of the first inspection camera 15.

Moreover, reliability of the machine is high because the control device 40 controls the drive of the first-paper-sheet-release-cam actuator 42 and the second-paper-sheet-release-cam actuator 43 on the basis of the results of the inspections by the first inspection camera 15 and the second inspection camera 27, and automatically switches between the delivery to either one of the two accepted-paper-sheet piles 37 and 38 and the delivery to the one wasted-paper-sheet pile 39.

It is needless to say that the present invention is not limited to the above embodiment and that various changes can be made without departing from the gist of the present invention. For example, the previous printing may be single-sided printing. Moreover, the intaglio printing may be carried out as double-sided printing.

### INDUSTRIAL APPLICABILITY

An intaglio printing press according to the present invention is capable of performing highly accurate quality inspection on previous printing by use of appropriate equipment and is therefore suitable for use in sheet-fed printing presses configured to print bank notes, securities, and the like.

### REFERENCE SIGNS LIST

10 FEEDER (SHEET FEEDING DEVICE)

11 FEEDER BOARD

12 SWING DEVICE

13 TRANSFER CYLINDER

14 TRANSFER CYLINDER (TRANSPORT CYLINDER)

15 FIRST INSPECTION CAMERA (FIRST INSPECTION DEVICE)

16 BRACKET

17a, 17b ILLUMINATING UNIT

18a, 18b AIR NOZZLE

19 HOLDDOWN ROLLER

20 INTAGLIO PRINTING UNIT (INTAGLIO PRINTING DEVICE)

21 IMPRESSION CYLINDER

22 PLATE CYLINDER

23 INK COLLECTING CYLINDER

24 CHABLON ROLLER

25 INKING DEVICE

26 WIPING TANK

26a WIPING ROLLER

27 SECOND INSPECTION CAMERA (SECOND INSPECTION DEVICE)

30 DELIVERY UNIT (SHEET DELIVERING DEVICE)

31 PAPER-SHEET DELIVERY CYLINDER

32 PAPER-SHEET DELIVERY CHAIN (TRANSPORT CHAIN)

33 GRIPPER BAR

33a GRIPPER

33b GRIPPER PAD

34 FIRST PAPER-SHEET RELEASE CAM

35 SECOND PAPER-SHEET RELEASE CAM

36 PAPER-SHEET RELEASE CAM

37, 38 ACCEPTED-PAPER-SHEET PILE (NORMAL-SHEET STACKING DEVICE)

39 WASTED-PAPER-SHEET PILE (DEFECTIVE-SHEET STACKING DEVICE)

40 CONTROL DEVICE (SWITCHING DEVICE)

41 COUNTER

42 FIRST-PAPER-SHEET-RELEASE-CAM ACTUATOR

43 SECOND-PAPER-SHEET-RELEASE-CAM ACTUATOR

W PAPER SHEET (SHEET)

1. An intaglio printing press comprising:
a sheet feeding device;
an intaglio printing device; and
a sheet delivering device,
the intaglio printing press being configured to perform intaglio printing on a sheet having been subjected to printing in a previous step, wherein
the intaglio printing press includes a first inspection device provided between the sheet feeding device and the intaglio printing device and configured to inspect printing quality of the sheet having been subjected to the printing in the previous step.

2. The intaglio printing press according to claim 1, wherein the first inspection device is configured to inspect one surface of the sheet opposite to a surface thereof to be subjected to the intaglio printing by the intaglio printing device, and
the intaglio printing press further includes a second inspection device configured to inspect the other surface of the sheet subjected to the intaglio printing by the intaglio printing device.

3. The intaglio printing press according to claim 1, wherein
the intaglio printing device includes:
an impression cylinder configured to hold and transport the sheet; and
an intaglio cylinder being in contact with the impression cylinder and configured to perform the intaglio printing on the other surface of the sheet transported on the impression cylinder, and
the first inspection device is disposed in such a way as to face a transport cylinder arranged upstream of the impression cylinder in a transport direction of the sheet and configured to transport the sheet while holding the sheet with the one surface thereof facing outside.

4. The intaglio printing press according to claim 3, wherein the second inspection device is disposed in such away as to face the impression cylinder of the intaglio printing device.

5. The intaglio printing press according to claim 1, wherein the sheet delivering device includes:
a normal-sheet stacking device to stack the sheet determined as normal as a result of the inspection by any one of the first inspection device and the second inspection device;
a defective-sheet stacking device to stack the sheet determined as defective as a result of the inspection by any one of the first inspection device and the second inspection device; and
a switching device configured to switch the destination to which the sheet is delivered.
